(19) United States
(12) Patent Application Publication
(10) Pub. No.: US 2008/0093403 A1
(43) Pub. Date: Apr. 24, 2008

(54) ATV article holder with single point of attachment

(76) Inventors: George D. Gates, South Jordan, UT (US); Travis D. Gates, Riverton, UT (US)

Correspondence Address: THORPE NORTH & WESTERN, LLP., P.O. Box 1219, SANDY, UT, 84091-1219, US

(21) Appl. No.: 11/586,332

(22) Filed: Oct. 24, 2006

(51) Int. Cl. B60R 9/00; B60R 7/00

(52) U.S. Cl. 224/401; 224/440

(57) ABSTRACT

An article holder for individual attachment of an article to an ATV comprises an attachment base, attachable to a support structure associated with the ATV and a holding member, configured to receive and hold the article therein. The holding member extends from the attachment base and includes at least three containment arms which collectively define a containment area for containing the article. The at least three containment arms are each biased toward to a neutral position such that the arms apply a securing force to the article as the containment arms are displaced by the article from the neutral position.

### FIELD OF THE INVENTION

1. Background

The present invention relates generally to devices suitable for attachment to all-terrain vehicles (“ATVs”) for holding a variety of articles. More specifically, the present invention relates to such devices that are suitable for holding such articles through a single attachment point to the ATV.

2. Related Art

Holding devices used on vehicles such as motorcycles, ATVs and the like have been utilized for many years to allow operators of the vehicles to carry various articles on the vehicle. For example, article holders such as those disclosed in U.S. Pat. No. 4,607,772 have been used to carry hunting and fishing equipment, tools, etc., on motorcycles, ATVs, and the like.

While such holders have enjoyed significant commercial success, they have proved problematic in a number of manners. For example, most such holders are designed for use in pairs, with an object such as a shovel handle or rifle resting within a pair of holders mounted to opposing sides of a section (e.g., the handlebar section) of an ATV. Such devices are in general not particularly well adapted to individually carry an elongate article. Instead, two or more of such holders are generally preferred for such operations.

While many articles can be held utilizing a pair of article holders, other types of articles are not well suited to be held at two spaced-apart points. For example, archery bows can be held by securing the two limbs of the bow to two individual, spaced-apart article holders. This can be problematic, however, in that securing the limbs of the bows to the holders (or to any rigid structure) could damage the limbs and render the bow unsafe to use. Also, due to the relatively odd shape of the grip handle of bows (as the handle is generally curved to fit the hand of a hunter), it has been difficult in the past to securely attach the grip handle to a conventional holder or other supporting structure.

While some attachment devices have been developed that attempt to retain the bow on the “riser” (or main body) of the bow, many hunters have other auxiliary devices attached to the riser (such as sights, quivers, etc.) that can interfere with mounting the bow on this area.

Thus, while the most practical location on a bow to secure the bow is the handle (as it is designed to be grasped and rarely has auxiliary structure attached thereto), conventional article holders are not designed to engage the handle of the bow to allow mounting of the bow to an ATV via the handle.

In addition to these considerations, utilizing a pair of conventional article holders requires that each of the pair be mounted on structure of the ATV in a manner that results in the object being held fitting properly within each of the holders. For example, when an elongate object is held by a pair of conventional article holders, the holders must be spaced the proper distance from each other and aligned on substantially the same plane as one another. However, many times there is not sufficient “real estate” on a desired structure of an ATV (e.g., on handlebars of the ATV) to properly space and/or orient two article holders.

### SUMMARY OF THE INVENTION

The present invention provides an article holder for individual attachment of an article to an ATV, including an attachment base, attachable to a support structure associated with the ATV. A holding member can be configured to receive and hold the article therein. The holding member can extend from the attachment base and can include at least three containment arms which collectively define a containment area for containing the article. The at least three containment arms can each be biased toward to a neutral position such that the arms apply a securing force to the article as the containment arms are displaced by the article from the neutral position.

In accordance with another embodiment of the invention, an article holder for individual attachment of an article to an ATV is provided, including an attachment base, attachable to a support structure associated with the ATV. A holding member can be configured to receive and hold the article therein. The holding member can extend away from the attachment base and can include at least three containment arms which collectively define a containment area for containing the article. At least one of the at least three containment arms can be resilient to provide a biased securing force to the article held in the containment area when the at least one containment arm is displaced by the article.

In accordance with another aspect of the invention, a method of storing an article on an ATV is provided, including: positioning the article adjacent a containment area of an article holder mounted to the ATV; and inserting the article between three containment arms of the article holder to cause at least one of the containment arms to resiliently deflect, at least one of the containment arms applying a securing force to the article as it is held in the containment area.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a front view of a holding device in accordance with an embodiment of the present invention;

FIG. 2 is a side view of the holding device of FIG. 1; and

FIG. 3 is a top view of the holding device of FIG. 1.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to an “upright arm” includes one or more of such arms.

### Definitions

In describing and claiming the present invention, the following terminology will be used in accordance with the definitions set forth below.

As used herein, the term “article” is to be understood to refer to an object that can be mounted to at least a portion of an ATV in order to be transported by the ATV. Examples of articles include, without limitation, yard tools, such as shovels, rakes, picks, etc., guns, bows, camera equipment, scopes, and also intermediate structures, such as tripods, rests, etc., on which such devices can be mounted or rested.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

### Invention

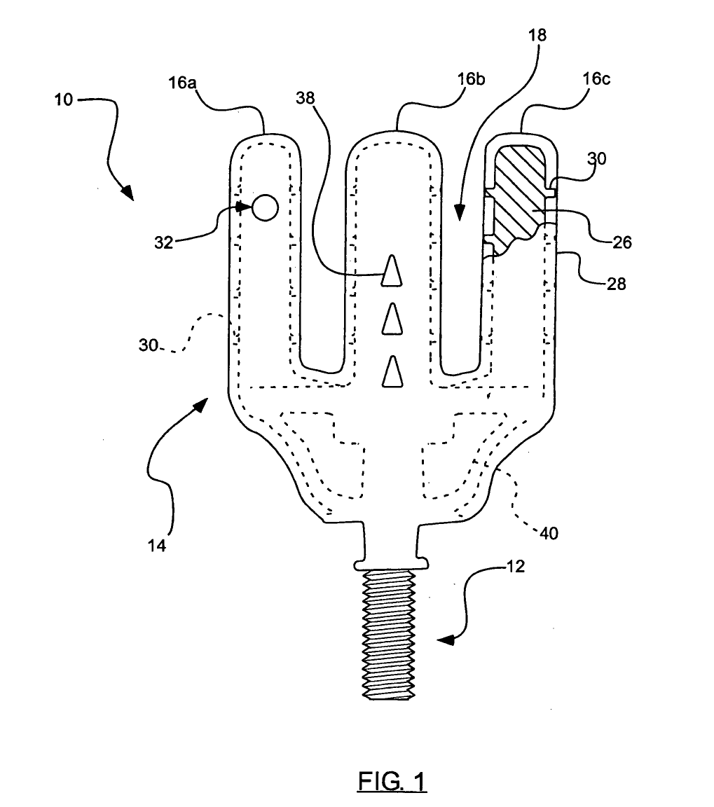

As illustrated in FIGS. 1-3, the present invention provides an article holder 10 for use in individually attaching an article to an ATV (not shown). When discussed herein, the use of the present article holders to “individually attach” an article to an ATV refers to the ability of the present article holders to secure articles, even elongate and awkwardly shaped articles, to an ATV by the use of only one article holder. This advantage of the present invention is in contrast to conventional article holders that often require two or more holders to safely or properly secure an article to an ATV.

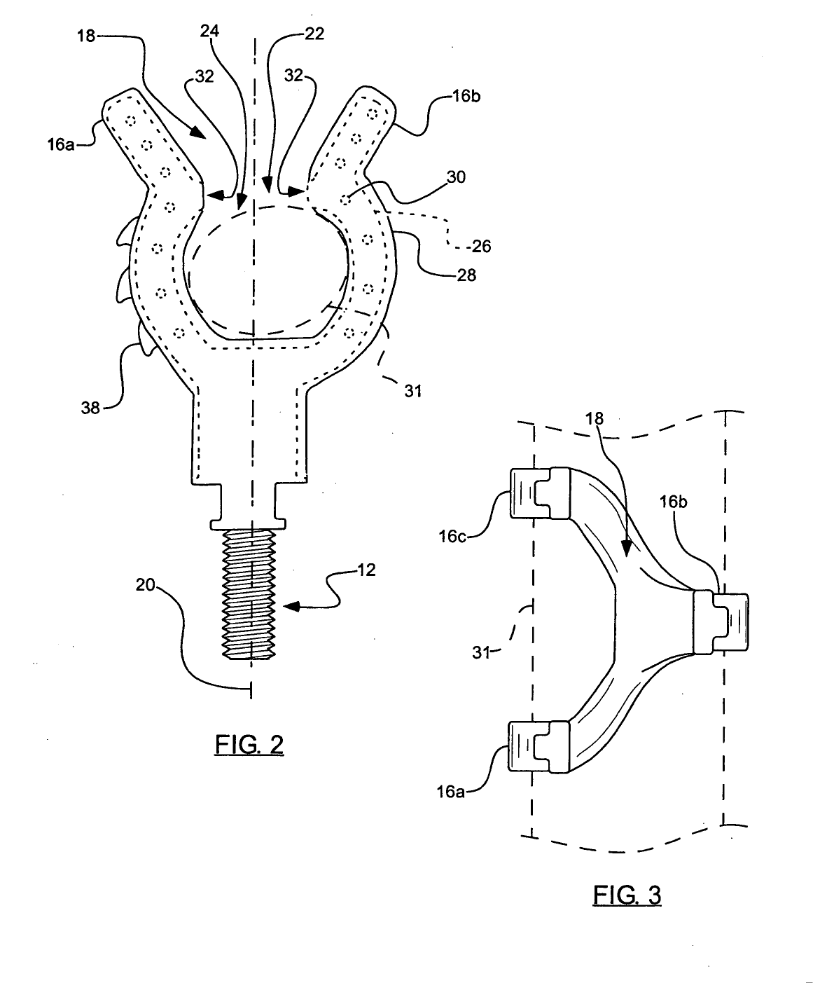

Generally, the article holder 10 can include an attachment base 12 that can be attached to various structure (not shown) of the ATV, such as handlebars of the ATV, a cargo rack of the ATV, etc. A holding member (shown generally at 14) can extend from the attachment base and can be configured to receive and hold an article (shown schematically at 31 in FIGS. 2 and 3) therein. The holding member can include at least three containment arms 16a, 16b and 16c which can collectively define a containment area 18 for containing the article.

In one embodiment of the invention, one or more of the at least three containment arms 16a, 16b and 16c can each be biased toward to a neutral position such that the arms apply a securing force to the article 31 as the containment arms are displaced by the article from the neutral position. The biasing force applied by the containment arms can be generated in a number of manners. For example, in one aspect of the invention, at least a portion of one or more of the containment arms can be made resilient. Resiliency can be provided by way of forming the arms from a material that, when formed in an appropriate shape, has the tendency to return to a neutral position (e.g., the position illustrated in the figures) after being displaced from the neutral position. Examples of suitable such materials include, without limitation, Nylon 6, supertough nylon, etc.

In normal operation, one or more of the containment arms can be displaced from a neutral position, and will return to the neutral position after the displacing force is removed. Thus, normal displacement of the containment arms will not result in significant permanent damage being done to the containment arms. While the containment arms 16a, 16b and 16c may not be formed from a material classified as “resilient” (the material may be relatively rigid, for example), the overall configuration of the containment arms can result in resiliency being provided to the containment arms.

The at least three containment arms 16a, 16b and 16c provide advantages not found in conventional article holders that generally include only two bifurcated arms. When attempting to mount an elongate object or article, such as a rifle or a bow, to an ATV utilizing such conventional article holders, two or more article holders have been required to restrict the article from tending to “rock” or “teeter” in the holder. In other words, if a single, dual-arm holder is utilized to carry an elongate object, the object must be centered within the holder or one side or another of the object will tend to move downwardly while the other side tends to move upwardly. Even if the object is properly centered on (or in) the holder and prevented from teetering in a vertical plane, the object can be subject to teetering in a horizontal plane (e.g., the ends of the object can move backwardly and forwardly relative to the ATV on which the dual-arm holder is mounted). Thus, using only one conventional article holder to secure an article to an ATV has resulted in an unacceptable degree of instability in the article that is meant to be secured.

In contrast, the present holder 10 can include at least three containment arms that can be arranged with two containment arms, e.g., 16a and 16c, facing the containment area 18 on a first side, and one containment arm, e.g., 16b, facing the containment area on an opposing side. In this manner, when an article is held within the containment area by the biasing force of one or more of the arms, the object is contacted by each of the three containment arms and is thereby restricted from the tendency to “rock” or “teeter” backward and forward (and/or upwardly and downwardly) within the containment area by the three-point contact with the holder 10. Thus, a single article holder in accordance with the present invention can be used to secure relatively elongate objects to an ATV while limiting or eliminating any tendency of such objects to “rock” or “teeter” within the holder.

As best appreciated from FIG. 2, the article holder 10 can include an attachment base 12 that can define an elongate central axis 20. In this embodiment of the invention, the containment area 18 can be volumetrically larger on a first side 22 of the elongate axis than on an opposing side 24 of the elongate axis. This feature of the invention can aid in securing within the holder objects that are relatively oddly shaped, such as the handles of bows. Typically, mounting bows to ATVs has proved problematic due to the relatively odd shape of bows in general, and the relatively odd shape of the grip handle of bows. While it may be possible to mount a bow to an ATV via the limbs of the bow, doing so can result in damaging the limbs or other portions of the bow. Without use of the limbs of bows as points of attachment, little structure of the bows remains as attachment locations, save the grip handle of the bows. The present invention can be used to advantageously utilize the grip handle area of a bow as a point of attachment of the bow to an ATV.

The article holder of the present invention can be formed from a variety of materials and in a variety of configurations. In one embodiment, the holder includes an inner, core material 26 that can be formed of a relatively rigid material such as supertough nylon. An outer, sheathing material 28 can be attached to, joined with, or formed around the inner core. The outer material can be formed of a relatively pliable material, such as the material sold under the tradename Sanoprene. Such a pliable material can have, for example, a Shore A hardness of around 65.

As shown in FIG. 1, the inner core material 26 can include a series of engagement elements 30 that can aid in maintaining the outer, sheathing material 28 in position about the inner core. In the embodiment shown, the engagement elements can include a series of post-like projections that extend outwardly from the inner core. While the projections shown extend from sides of the containment arms 16a, 16b and 16c at right angles to the containment area 18, in some embodiments of the invention (not shown), the projections can extend toward the containment area, or in a direction opposite of the containment area.

As also shown in FIGS. 1 and 2, in one aspect of the invention, one or more of the containment arms can include a portion or section 32 where a portion of the inner, core material 26 can extend through (or can otherwise be exposed by) the outer, sheathing material 28. This aspect of the invention can be advantageous in that the outer sheathing material is often selected based on very pliable properties that provide a good cushioning and/or gripping interface with the article being held. However, it is often the case that such materials also provide a very high-friction interface between materials (e.g., the article being held will not easily slide on or over the outer sheathing material). In contrast, as the inner core material is often formed of a relatively rigid material (yet capable of providing a resilient response to bending), it often provides a relatively low-friction interface.

As the locations 32 coincide with the area at which an object inserted into the containment area 18 will contact one or more of the containment arms 16a, 16b or 16c, it may be the case that the relatively pliable material 28 positioned on the arms at this location may serve to restrict or inhibit movement of the article past the locations 32 and into the containment area. The present invention addresses this potential problem by including sections of the relatively low-friction, inner material 28 on or in the restraining arms at the location where an object being inserted into the containment area will contact the arms. In this manner, the object can be relatively easily inserted into the containment area (while deflecting one or more of the containment arms from the neutral position as it travels into the containment area), yet can be firmly engaged by the outer, sheathing material once disposed in the containment area.

In addition to having the inner, core material 26 protrude through the outer, sheathing material 28 in the locations 32 shown, it is contemplated that the outer, sheathing material can provide full coverage over the locations 32 and that pieces or portions of the inner material (or another suitable material) can be applied to the locations 32 to provide a relatively low-friction interface at these locations.

As shown in FIGS. 1 and 2, in one aspect of the invention, the article holder 10 can include one or more engagement nubs 38 that can be used to secure an elastic strap (not shown) about the article holder (and the article 31 contained in the holder) to further ensure that the article is firmly held within the containment arms 16a, 16b and 16c. The nubs can be formed from the same outer, sheathing material as the remainder of the holder, or can be formed from a different material. The nubs can be integrally formed with the outer, sheathing material, or can be attached, bonded or otherwise joined to the outer sheathing material.

As shown in FIG. 1, the inner, core material can include one or more reduced-geometry sections 40 that can aid in both enhancing an overall stiffness of the holder 10, and/or can aid in reducing an overall weight of the holder. The reduced-geometry sections can be formed in a variety of shapes and can be located within the inner, core material in a variety of positions.

In addition to the structural considerations discussed above, the present invention also provides a method of storing an article on an ATV, including: positioning the article adjacent a containment area of an article holder mounted to the ATV; and inserting the article between three containment arms of the article holder to cause at least one of the containment arms to resiliently deflect, at least one of the containment arms applying a securing force to the article as it is held in the containment area.

In one aspect, the article is a bow, and inserting the article between the containment arms can include inserting a handle portion of the bow between the containment arms.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. An article holder for individual attachment of an article to an ATV, comprising:
an attachment base, attachable to a support structure associated with the ATV; and
a holding member, configured to receive and hold the article therein, the holding member extending from the attachment base and including at least three containment arms which collectively define a containment area for containing the article;
the at least three containment arms each being biased toward to a neutral position such that the arms apply a securing force to the article as the containment arms are displaced by the article from the neutral position.

2. The article holder of claim 1, wherein at least one of the containment arms is resilient.

3. The article holder of claim 1, wherein the attachment base defines an elongate central axis and wherein the containment area is volumetrically larger on one side of the elongate axis than on an opposing side of the elongate axis.

4. The article holder of claim 3, wherein two of the containment arms are positioned on a first side of the containment area and one of the containment arms is positioned on a second side of the containment area.

5. The article holder of claim 4, wherein the containment area is larger in volume on the side bordered by the two containment arms than on the side bordered by the one containment arm.

6. The article holder of claim 1, wherein the holder is operable to receive and secure therein a handle of a bow.

7. The article holder of claim 1, wherein at least one of the containment arms includes a portion having an innermost material protruding through an outermost material.

8. The article holder of claim 1, wherein the holder is formed of at least two materials: an inner, relatively rigid material, and an outer, relatively pliable sheathing material.

9. An article holder for individual attachment of an article to an ATV, comprising:
an attachment base, attachable to a support structure associated with the ATV; and
a holding member, configured to receive and hold the article therein, the holding member extending away from the attachment base and including at least three containment arms which collectively define a containment area for containing the article;
at least one of the at least three containment arms being resilient to provide a biased securing force to the article held in the containment area when the at least one containment arm is displaced by the article.

10. The article holder of claim 9, wherein the attachment base defines a central elongate axis and wherein the containment area is volumetrically larger on one side of the elongate axis than on an opposing side of the elongate axis.

11. The article holder of claim 9, wherein two of the containment arms are positioned on a first side of the containment area and one of the containment arms is positioned on a second side of the containment area.

12. The article holder of claim 11, wherein the containment area is larger in volume on the side bordered by the two containment arms than on the side bordered by the one containment arm.

13. The article holder of claim 9, wherein the holder is operable to receive and secure therein a handle of a bow.

14. The article holder of claim 9, wherein at least one of the containment arms includes a portion having an innermost material protruding through an outermost material.

15. The article holder of claim 9, wherein the holder is formed of at least two materials: an inner, relatively rigid material, and an outer, relatively pliable sheathing material.

16. A method of storing an article on an ATV, comprising the steps of:
positioning the article adjacent a containment area of an article holder mounted to the ATV;
inserting the article between three containment arms of the article holder to cause at least one of the containment arms to resiliently deflect, at least one of the containment arms applying a securing force to the article as it is held in the containment area.

17. The method of claim 16, wherein the article is a bow, and wherein inserting the article between the containment arms comprises inserting a handle portion of the bow between the containment arms.

18. The method of claim 17, wherein the attachment base defines a central elongate axis and wherein the containment area is volumetrically larger on one side of the elongate axis than on an opposing side of the elongate axis.

19. The method of claim 16, wherein two of the containment arms are positioned on a first side of the containment area and one of the containment arms is positioned on a second side of the containment area.

20. The method of claim 19, wherein the containment area is larger in volume on the side bordered by the two containment arms than on the side bordered by the one containment arm.

21. The method of claim 16, wherein at least one of the containment arms includes a portion having an innermost material protruding through an outermost material.
